(19) United States
(12) Patent Application Publication
(10) Pub. No.: US 2009/0047458 A1
(43) Pub. Date: Feb. 19, 2009

(54) Image Receiving Sheet for Electrostatically Charged Liquid Development and Image Receiving Label for Electrostatically Charged Liquid Development

(75) Inventor: Soichiro Fujinaga, Tokyo (JP)

Correspondence Address: KRATZ, QUINTOS & HANSON, LLP, 1420 K Street, N.W., Suite 400, WASHINGTON, DC, 20005, US

(73) Assignee: LINTEC CORPORATION, Tokyo (JP)

(21) Appl. No.: 12/084,689

(22) PCT Filed: Aug. 28, 2006
(86) PCT No.: PCT/JP2006/316831

§ 371 Date: May 8, 2008

(30) Foreign Application Priority Data
Nov. 10, 2005 (JP) 2005-326370

(51) Int. Cl. B32B 7/10; C08K 5/05; B32B 5/00

(52) U.S. Cl. 428/41.3; 524/389; 428/336

(57) ABSTRACT

An object of the invention is to provide an image receiving sheet for electrostatically charged liquid development and an image receiving label for electrostatically charged liquid development having an image receiving layer excellent in adherence to liquid toner for electrostatic charge development and also in adherence to the substrate. As a means for solving it, the image receiving sheet for electrostatically charged liquid development of the invention is characterized by having an image receiving layer formed by applying a coating liquid containing an ethylene/methacrylic acid resin to at least one surface of a substrate followed by drying it.

### TECHNICAL FIELD

The present invention relates to an image receiving sheet for electrostatically charged liquid development and an image receiving label for electrostatically charged liquid development that are excellent in adherence to liquid toner for use in electrostatically charged liquid development.

### BACKGROUND ART

At present when the needs of consumers diversify, the tendency has become noticeable toward the requirement of production of a small number but a variety of prints. Accordingly, for meeting the requirement, an electrophotographic method has been specifically noted, not requiring a plate-making step that takes expense and time. In particular, as compared with a dry electrophotographic method that uses a powder toner, an electrostatic charge development method of a wet electrophotographic method that uses a liquid toner may attain formation of high-definition images on the same level as that in a gravure printing system or an offset printing system that enables formation of high-definition image prints, since the mean particle size of the particles that constitutes the toner is small. The electrostatic charge development method comprises first forming an electrostatic latent image by irradiating a charged drum with a laser to resolve the charge, and then contacting the latent image with a charged liquid toner to develop the image. Next, the image is electrostatically transferred from the drum to an intermediate transfer medium, and on the intermediate transfer medium, the image is thermally fused and transferred onto an image receiving sheet by heat and pressure to thereby fix the image thereon.

It is well known that, when the image receiving sheet is a plastic film or a plastic sheet, then the adherence between toner and the image receiving sheet is poor, therefore causing a problem that toner often peels from the image receiving sheet. Even in a case where the substrate of the image receiving sheet is paper, it is also well known that the adherence between toner and the image receiving sheet is low, depending on the type of the coating agent provided on the paper surface, therefore also causing a problem that toner often peels from the image receiving sheet. Accordingly, for improving the adherence between a liquid toner and an image receiving sheet, for example, Patent Reference 1 describes a sheet prepared by coating the surface of a substrate with a polyethylene-based resin to be an image receiving layer thereon. Patent Reference 2 describes an object for print such as plastic film, coated with a primer layer of an ethylene/acrylic acid resin or a polybutadiene resin to be an image receiving layer.

### Patent Reference 1: JP 9-281738 A

### Patent Reference 2: JP 10-76744 A

### DISCLOSURE OF THE INVENTION

### Problems that the Invention is to Solve

However, the image receiving sheets described in Patent Reference 1 and Patent Reference 2 are problematic in that the adherence of the image receiving layer to liquid toner is insufficient and the problem is remarkable especially in halftone printing to give dot images. In addition, the adherence between the substrate and the image receiving layer is also insufficient.

Accordingly, an object of the present invention is to provide an image receiving sheet for electrostatically charged liquid development and an image receiving label for electrostatically charged liquid development that have an image receiving layer excellent in adherence to liquid toner for electrostatic charge development and also in adherence to the substrate.

### Means for Solving the Problems

The present inventor has assiduously studied in consideration of the above-mentioned points and, as a result, has found that, when a coating liquid containing an ethylene/methacrylic acid resin is applied to a substrate and dried to form an image receiving layer thereon, then the image receiving layer exhibits excellent adherence to liquid toner for electrostatic charge development and is excellent also in adherence to the substrate.

The image receiving sheet for electrostatically charged liquid development of the invention made on the basis of the above-mentioned finding is, as stated in claim 1, characterized by having an image receiving layer formed by applying a coating liquid containing an ethylene/methacrylic acid resin to at least one surface of a substrate followed by drying it.

The image receiving sheet for electrostatically charged liquid development stated in claim 2 is characterized in that, in the image receiving sheet for electrostatically charged liquid development stated in claim 1, a coating liquid prepared by diluting an aqueous dispersion of an ethylene/methacrylic acid resin obtained by mechanically forcedly dispersing an ethylene/methacrylic acid resin, with a mixed solvent comprising water, methyl alcohol and isopropyl alcohol is used as the coating liquid containing an ethylene/methacrylic acid resin.

The image receiving sheet for electrostatically charged liquid development stated in claim 3 is characterized in that, of the image receiving sheet for electrostatically charged liquid development stated in any of claim 1 or 2, it is used for electrostatic charge development with a liquid toner in which the fixing resin is an ethylene/(meth)acrylic acid resin.

The image receiving sheet for electrostatically charged liquid development stated in claim 4 is characterized in that, in the image receiving sheet for electrostatically charged liquid development stated in any of claims 1 to 3, the thickness of the image receiving layer is from 0.1 to 5.0 μm.

The image receiving label for electrostatically charged liquid development of the invention is, as stated in claim 5, characterized in that an adhesive layer and a release liner are laminated in that order on the image receiving sheet for electrostatically charged liquid development stated in any of claims 1 to 4, on the side of the substrate thereof opposite to the side coated with the image receiving layer.

### ADVANTAGES OF THE INVENTION

In the image receiving sheet for electrostatically charged liquid development of the invention, the image receiving layer formed by applying a coating liquid containing an ethylene/methacrylic acid resin to at least one surface of a substrate followed by drying it exhibits excellent adherence to liquid toner for electrostatic charge development and is excellent in adherence to the substrate. Accordingly, using the image receiving sheet for electrostatically charged liquid development of the invention, for example, even in halftone printing, the transferred image may be well fixed. Further, in case where a coating liquid prepared by diluting an aqueous dispersion of an ethylene/methacrylic acid resin obtained by mechanically forcedly dispersing an ethylene/methacrylic acid resin, with a mixed solvent comprising water, methyl alcohol and isopropyl alcohol is used as the coating liquid, the adherence between the image receiving layer formed by applying and drying the coating liquid and a liquid toner is extremely improved and, in addition, the formed image receiving layer can have a smooth surface condition and can be excellent in transparency. As so described in the above, Patent Reference 2 describes formation of an image forming layer comprising an ethylene/acrylic acid resin on the surface of a substrate; however, as will be clarified in the following Examples, the ethylene/methacrylic acid resin used as the constitutive material of the image receiving layer in the present invention, though having only a slight difference from an ethylene/acrylic acid resin in point of the chemical structure, produces a great difference from it in point of the adherence between the image receiving layer and a substrate and a liquid toner, and this is a surprising fact that could not be anticipated by anyone skilled in the art.

### BEST MODE FOR CARRYING OUT THE INVENTION

The image receiving sheet for electrostatically charged liquid development of the invention has an image receiving layer formed by applying a coating liquid containing an ethylene/methacrylic acid resin to at least one surface of a substrate followed by drying it.

The coating liquid that contains an ethylene/methacrylic acid resin includes, for example, a coating liquid prepared by diluting an aqueous dispersion of an ethylene/methacrylic acid resin obtained by mechanically forcedly dispersing an ethylene/methacrylic acid resin according to the method described in JP 62-29447 B, with a mixed solvent comprising water, methyl alcohol and isopropyl alcohol. The ethylene/methacrylic acid resin is a resin obtained by copolymerizing ethylene and methacrylic acid, and in case where it is mechanically forcedly dispersed and used, its mean particle size is preferably at most 2.0 μm, more preferably at most 1.5 μm. When the mean particle size is more than 2.0 μm, then the surface of the image receiving layer may be roughened, and it is undesirable since the image receiving layer may look cloudy owing to diffused reflection of light thereon. The mixed solvent to be used for diluting the aqueous dispersion of an ethylene/methacrylic acid resin is preferably one prepared by mixing from 20 to 60 parts by weight of methyl alcohol and from 15 to 40 parts by weight of isopropyl alcohol in 100 parts by weight of water. Using the mixed solvent of the type makes it possible to form, on the surface of a substrate, an image receiving layer having a smooth and good surface condition and excellent in transparency after dried. When water alone is used for diluting the aqueous dispersion of an ethylene/methacrylic acid resin, then the coating liquid may be repelled by the coated surface; when methyl alcohol alone is used, then the coated surface may be foamed; and when isopropyl alcohol alone is used, then the coated surface could not have a smooth condition but may be roughened, and therefore these are impracticable.

In case where a coating liquid prepared by diluting an aqueous dispersion of an ethylene/methacrylic acid resin obtained by mechanically forcedly dispersing an ethylene/methacrylic acid resin, with a mixed solvent comprising water, methyl alcohol and isopropyl alcohol is used, the image receiving layer formed may have a number of functional groups, as compared with a case where a coating liquid prepared by diluting a neutralized aqueous solution of an ethylene/methacrylic acid resin, which is in the form of an alkali salt such as an ammonia or amine salt or a metal salt such as a sodium or zinc salt of an ethylene/methacrylic acid resin, with a solvent of water, alcohol or the like is used, and therefore, it is desirable because the polarity of the layer increases and the adherence thereof to liquid toner increases further. In case where a polyester film or the like having polarity is used as the substrate, it is favorable since the adherence between the image receiving layer and the substrate is improved. However, even when a coating liquid prepared by diluting a neutralized aqueous solution of an ethylene/methacrylic acid, which is in the form of an alkali salt such as an ammonia or amine salt or a metal salt such as a sodium or zinc salt of an ethylene/methacrylic acid resin, with a solvent such as water, alcohol or the like is used, the intended effect of the invention can be fully attained, and therefore, in the invention, the coating liquid of the type may also be used.

For antiblocking, an inorganic pigment and an organic pigment may be suitably added to the coating liquid; and a defoaming agent, a UV absorbent, an antioxidant, a leveling agent and a viscosity-controlling agent may also be suitably added thereto.

The coating liquid may be applied to the surface of a substrate, for example, with an air knife coater, a blade coater, a reverse roll coater, a gravure coater, a bar coater or the like. Above all, a gravure coater is favorably used. For drying the coating liquid applied to the surface of a substrate, for example, employable is hot air drying at 90 to 120° C.

The thickness of the image receiving layer formed on the surface of a substrate in the manner as above is preferably from 0.1 to 5.0 μm, more preferably from 1.0 to 3.0 μm. When the thickness of the image receiving layer is less than 0.1 μm, then the image receiving layer could hardly have stable adherence to the substrate; but when larger than 5.0 μm, it is also unfavorable since the rolled substrate may have a trouble of blocking. In case where a coating liquid prepared by diluting an aqueous dispersion of an ethylene/methacrylic acid resin obtained by mechanically forcedly dispersing an ethylene/methacrylic acid resin, with a mixed solvent comprising water, methyl alcohol and isopropyl alcohol is used, the thickness of the image receiving layer is preferably larger than the mean particle size of the ethylene/methacrylic acid resin in the coating liquid. When the thickness of the image receiving layer is smaller than the mean particle size of the ethylene/methacrylic acid resin in the coating liquid, then the surface of the image receiving layer may be roughened, and it is undesirable since the image receiving layer may look cloudy owing to diffused reflection of light thereon. As a concrete embodiment, there is mentioned an example of forming an image receiving layer having a thickness of from 1.0 to 3.0 μm, using an ethylene/methacrylic acid resin having a mean particle size of from 0.5 to 0.9 μm.

The substrate for use in the invention includes plastic films such as polyester film, polyethylene film, polypropylene film, nylon film; and mirror-coated paper, synthetic paper (polypropylene base, vinyl chloride base, etc.), plain paper, etc. Above all, favorably used are polyester films such as typically polyethylene terephthalate film. This is because, as having polarity, a polyester film may have excellent adherence to an image receiving layer (this effect is remarkable when a coating liquid prepared by diluting an aqueous dispersion of an ethylene/methacrylic acid resin obtained by mechanically forcedly dispersing an ethylene/methacrylic acid resin, with a mixed solvent comprising water, methyl alcohol and isopropyl alcohol is used). The thickness of the substrate is preferably from 10 to 300 μm, more preferably from 20 to 200 μm. For improving the adherence between the substrate and an image receiving layer, the substrate may be processed for corona treatment, flame treatment or the like. An anchor coat layer comprising a polyester resin, an acrylic resin or the like may be provided on the substrate, and an image receiving layer may be formed on the anchor coat layer.

The image receiving sheet for electrostatically charged liquid development of the invention, produced in the manner as above, may be processed into an image receiving label for electrostatically charged liquid development, by laminating an adhesive layer and a release liner in that order on the surface of the substrate thereof opposite to the surface coated with the image receiving layer.

The adhesive to constitute the adhesive layer may be any of an emulsion-type, a solvent-type or a solvent-free type adhesive. For example, an adhesive containing an acrylate copolymer, and in addition to it, rubber-base, polyester-base and polyurethane-base adhesives are usable. In case where heat resistance is required, a heat-resistant silicone-base adhesive may be used. Preferably, the thickness of the adhesive layer is from 5 to 60 μm, more preferably from 15 to 40 μm. When the thickness of the adhesive layer is less than 5 μm, then the adhesion power may be insufficient; but when more than 60 μm, then it is also unfavorable since the adhesive may protrude out. For forming the adhesive layer, for example, an adhesive may be applied on the surface of a substrate, using a knife coater, a roll coater, a die coater or the like, and then it may be dried thereon. A release liner is laminated on the thus-formed adhesive layer, thereby giving an image receiving label for electrostatically charged liquid development. The image receiving label for electrostatically charged liquid development may also be produced by applying an adhesive to the surface of a release liner by the use of a knife coater, a roll coater or the like, then drying it to form an adhesive layer, and laminating the thus-formed adhesive layer onto the surface of the substrate opposite to the side thereof coated with an image receiving layer. This production method is favorable since the heating in the drying step of forming the adhesive layer does not cause damage to the image receiving layer.

The release liner may be prepared by coating a plastic film such as polyethylene terephthalate film, foamed polyethylene terephthalate film or polypropylene film, or paper such as coated paper, glassine paper or any other polyethylene laminate paper with a release agent such as silicone-based, fluorine-containing or long-chain alkyl-based agent. Not specifically defined, the thickness of the release liner may be generally from 20 to 200 μm or so.

The liquid toner for electrostatic charge development, which is applied to the image receiving sheet for electrostatically charged liquid development of the invention for forming an image layer, may be any ordinary one prepared by dispersing a colorant for visualization, a fixing resin for fixing the colorant on an image receiving sheet, and a charge controlling agent for controlling electric properties, in a carrier liquid.

The colorant includes known pigments and dyes heretofore used as the colorant in liquid toner for electrostatic charge development, for example, Hansa yellow, benzidine yellow, benzidine orange, fast red, brilliant carmine 3B, copper phthalocyanine blue, phthalocyanine green, spirit black, oil blue, alkali blue, rhodamine 6B, nigrosine, carbon black, dichloroquinacridone, isoindoline, titanium oxide, etc.

The fixing resin may be a known resin heretofore used as the fixing resin in liquid toner for electrostatic charge development, for example, thermoplastic resins such as polystyrene, styrene/acrylic acid copolymer, polyacrylic acid, polyethylene, ethylene/(meth)acrylic acid copolymer, polypropylene, polyester, polyurethane, polyamide; and these may be used either singly or as their mixtures. “(Meth)acrylic acid” means “acrylic acid and/or methacrylic acid”. The fixing resin favorable for the image receiving sheet for electrostatically charged liquid development of the invention is an ethylene/(meth)acrylic acid resin.

As the charge controlling agent, usable are metal salts of resin acids such as naphthenic acid, octenoic acid, oleic acid, stearic acid, metal salts of sulfosuccinates, nonionic surfactants such as polyoxyethylated alkylamine, oils and fats such as lecithin, linseed oil, polyvinylpyrrolidone, organic acid esters of polyalcohols and others that have heretofore been used as a charge controlling agent for liquid toner for electrostatic charge development.

As the carrier liquid, usable is a high-insulation, low-dielectric constant hydrocarbon solvent. Preferred is a branched-chain aliphatic hydrocarbon, concretely including Isoper G, Isoper L, Isoper M (trade name by Exxon Chemical), etc.

### EXAMPLES

Next, the image receiving sheet for electrostatically charged liquid development and the image receiving label for electrostatically charged liquid development of the invention are described with reference Examples and Comparative Examples; however, the invention should not be limited to the following Examples.

### Example 1

An aqueous dispersion of an ethylene/methacrylic acid resin prepared by mechanically forcedly dispersing an ethylene/methacrylic acid resin (Chuo Rika Kogyo's trade name: Aquatec AC3100, having a mean particle size of 0.7 μm and a resin content of 45% by weight) was diluted with a mixed solvent of water/methyl alcohol/isopropyl alcohol in a ratio of 60 parts by weight/24 parts by weight/16 parts by weight so as to have a resin solid content of 9.5% by weight, thereby preparing a coating liquid. The coating liquid was applied onto a substrate of a corona-treated polyethylene terephthalate film having a thickness of 50 μm (Toray's trade name: PET50 T-60), using a gravure coater, and dried at 110° C., thereby producing an image receiving sheet for electrostatically charged liquid development having a 2.0 μm-thick image receiving layer. The image receiving layer had a smooth surface, and after dried, its transparency was excellent.

Next, an adhesive prepared by adding 3 parts by weight of a crosslinking agent (Nippon Polyurethane Industry's trade name: Coronate L) to 100 parts by weight of an acrylic adhesive (Toyo Ink Manufacturing's trade name: Oribain BPS-1109) was applied to the surface of the release layer of a release liner prepared by coating the surface of glassine paper with silicone (Lintec's trade name: SP-8K Blue, having a thickness of 90 μm), using a roll coater, in such a manner that the dry thickness thereof could be 30 μm, and then dried to form an adhesive layer thereon. The adhesive layer on the release liner was laminated on the image receiving sheet for electrostatically charged liquid development, on the side of the substrate thereof opposite to the side coated with the image receiving layer, thereby producing an image receiving label for electrostatically charged liquid development.

### Example 2

An ammonia-neutralized aqueous solution of an ethylene/methacrylic acid resin (Toho Chemical Industry's trade name: Hitec SC100) was diluted with a mixed solvent of water/methyl alcohol/isopropyl alcohol in a ratio of 60 parts by weight/24 parts by weight/16 parts by weight so as to have a resin solid content of 9.5% by weight, thereby preparing a coating liquid. Using this coating liquid and in the same manner as in Example 1, an image receiving sheet for electrostatically charged liquid development and an image receiving label for electrostatically charged liquid development of the invention were produced.

### Comparative Example

An ammonia-neutralized aqueous solution of an ethylene/acrylic acid resin (Sumitomo Seika Chemicals's trade name: Zaikthene A) was diluted with a mixed solvent of water/methyl alcohol/isopropyl alcohol in a ratio of 60 parts by weight/24 parts by weight/16 parts by weight so as to have a resin solid content of 9.5% by weight, thereby preparing a coating liquid. Using this coating liquid and in the same manner as in Example 1, an image receiving sheet for electrostatically charged liquid development and an image receiving label for electrostatically charged liquid development of the invention were produced.

(Method of Evaluation of Adherence between Substrate and Image Receiving Layer)

The image receiving labels for electrostatically charged liquid development obtained in Examples 1 and 2 and Comparative Example were evaluated as points for the adherence between the substrate and the image receiving layer, according to the X-cut tape method of JIS K 5400 (1990). Using a cutter knife, the image receiving layer (unprinted surface) of the image receiving label for electrostatically charged liquid development was cut as X-shaped scratches crossing at an angle of 30 degrees and having a length of 40 mm (X-cut) to the depth reaching the substrate, and a Nichiban's cellophane tape was stuck to the crossing two scratches in such a manner that the tape-adhering part could be about 50 mm long; then this was uniformly rubbed with an eraser, whereby the tape was completely stuck. In 1 or 2 minutes after the sticking, one end of the tape was picked up, and the tape was momentarily peeled off with its end kept perpendicular to the image receiving layer. When the tape was peeled off, the sample with no X-cut peel was given 10 points; and the samples were given 8 points, 6 points, 4 points or 2 points in that order depending on the degree of X-cut peels; and the sample in which the peeled part was larger than the X-cut part was given 0 point.

(Method of Evaluation of Adherence between Liquid Toner and Image Receiving Layer)

Using a black liquid toner for electrostatic charge development in which the fixing resin is an ethylene/(meth)acrylic acid resin (Hewlett-Packard's liquid toner for electrostatic charge development “ElectroInk Mark 4.0-Black”), the image receiving labels for electrostatically charged liquid development obtained in Examples 1 and 2 and Comparative Example were printed for solid prints and halftone prints (halftone density 25%), as set in a printer of an electrostatically charged liquid development print system (Hewlett-Packard's digital printer “Press WS 4000”), then a Nichiban's cellophane tape was stuck to the printed surface under a load of 20 N, and then peeled by hand. Before sticking and after peeling, the reflection density of the cellophane tape-stuck area was determined with a spectral color-difference meter (Nippon Denshoku Industries's Handy Spectral Color-Difference Meter “NF 777CE”); and from the found data, the adherence was evaluated based on the density retentiveness shown by the following formula:

Density Retentiveness (%)=(reflection density after sticking/reflection density before peeling)×100.

TABLE 1

| | | Adherence | | |
|---|---|---|---|---|
| | | between | Adherence between Liquid | |
| | | Substrate and | Toner and Image Receiving | |
| | | Image | Layer | |
| | | Receiving | Density Retentiveness (%) | |
| | | Layer Score in | | Halftone |
| | Coating Liquid | Evaluation | Solid Printing | Printing |
| Example 1 | aqueous dispersion of | 10 | 100 | 97 |
| | ethylene/methacrylic | | | |
| | acid resin | | | |
| Example 2 | ammonia-neutralized | 6 | 100 | 76 |
| | aqueous solution of | | | |
| | ethylene/methacrylic | | | |
| | acid resin | | | |
| Comparative | ammonia-neutralized | 0 | 90 | 0 |
| Example | aqueous solution of | | | |
| | ethylene/acrylic acid | | | |
| | resin | | | |

As is obvious from Table 1, the image receiving label for electrostatically charged liquid development of Comparative Example, for which the constitutive material of the image receiving layer was an ethylene/acrylic acid resin, was poor in the adherence between the substrate and the image receiving layer; and when it was halftone-printed, the density retentiveness that could be an index of the adherence between the liquid toner and the image receiving layer was 0%, and this confirmed the presence of no adherence between the two. As opposed to it, the image receiving labels for electrostatically charged liquid development of Example 1 and Example 2, for which the constitutive material of the image receiving layer was an ethylene/methacrylic acid resin, had high adherence between the substrate and the image receiving layer; and when they were halftone-printed, the density retentiveness that could be an index of the adherence between the liquid toner and the image receiving layer was high, and this confirmed excellent adherence between the two. The effect was especially remarkable in Example 1, in which the coating liquid was prepared by diluting an aqueous dispersion of an ethylene/methacrylic acid resin obtained by mechanically forcedly dispersing an ethylene/methacrylic acid resin, with a mixed solvent of water, methyl alcohol and isopropyl alcohol. From the above results, it is known that using an ethylene/methacrylic acid resin as the constitutive material of an image receiving layer, though the resin has only a slight difference from an ethylene/acrylic acid resin in point of the chemical structure, may make the adherence of the image receiving layer to the substrate and to liquid toner excellent.

### INDUSTRIAL APPLICABILITY

The invention has industrial applicability in that it provides an image receiving sheet for electrostatically charged liquid development and an image receiving label for electrostatically charged liquid development having an image receiving layer excellent in adherence to liquid toner for electrostatic charge development and also in adherence to the substrate.

1. An image receiving sheet for electrostatically charged liquid development characterized by having an image receiving layer formed by applying a coating liquid prepared by diluting an aqueous dispersion of an ethylene/methacrylic acid resin obtained by mechanically forcedly dispersing an ethylene/methacrylic acid resin, with a mixed solvent comprising water, methyl alcohol and isopropyl alcohol, to at least one surface of a substrate followed by drying it.

2. (canceled)

3. The image receiving sheet for electrostatically charged liquid development as claimed in claim 1, which is used for electrostatic charge development with a liquid toner in which the fixing resin is an ethylene/(meth)acrylic acid resin.

4. The image receiving sheet for electrostatically charged liquid development as claimed in claim 1, wherein the thickness of the image receiving layer is from 0.1 to 5.0 μm.

5. An image receiving label for electrostatically charged liquid development characterized in that an adhesive layer and a release liner are laminated in that order on the image receiving sheet for electrostatically charged liquid development of claim 1, on the side of the substrate thereof opposite to the side coated with the image receiving layer.
